(19) United States
(12) Patent Application Publication
(10) Pub. No.: US 2007/0273688 A1
(43) Pub. Date: Nov. 29, 2007

(54) System and method of applying geometric surface features to volumetric CAE mesh models

(76) Inventors: Yifan Chen, Ann Arbor, MI (US); Basavaraj Tonshal, Livonia, MI (US)

Correspondence Address: TUNG & ASSOCIATES, 838 WEST LONG LAKE, SUITE 120, BLOOMFIELD HILLS, MI, 48302, US

(21) Appl. No.: 11/440,387

(22) Filed: May 24, 2006

(51) Int. Cl. G06T 17/00

(52) U.S. Cl. 345/420

(57) ABSTRACT

A CAE mesh modeling system and method for use with a CAE mesh morphing software system to interactively determine a deformation of design mesh models selected from solid meshes, multiple layers of surface meshes, or a combination of each using a base model and defined deformation features. The methodology advantageously defines a volumetric region of the model for modification, maintains a smooth transition between the volumetric region and the rest of the model, and simultaneously modifies all nodes and associated projected nodes within the affected volumetric region in a controlled manner. A new deformation volumetric model feature is created which includes the deformed base model. The methodology takes advantage of similarities between models by treating a set of mathematical operations associated with each mesh deformation as an independent entity that can be stored separately and reapplied to deform another model at another time.

### FIELD OF THE INVENTION

The present invention generally relates to volumetric mesh modeling using Direct Surface Manipulation (DSM) for use in the field of deforming a 3-D solid in Computer-Aided Engineering (CAE) analysis.

### BACKGROUND

At the same time, enhanced visualization software tools have been developed that allow for interactive display and manipulation of large-scale geometric models of the product, including models developed using Computer-Aided Design (CAD). As Computer Aided Engineering (CAE) becomes a more cost- and time-effective alternative to the traditional mechanical design and engineering approaches utilizing physical prototypes, the need has increased dramatically for the capability to directly reshape mesh models rather then CAD models.

Currently, the CAD model of a product is converted into a mesh model suitable for CAE analysis, such as a finite element mesh model. The Computer-Aided Engineering (CAE) simulation is performed by the user using a predetermined set of parameters, and the results of the simulation are available for additional study and evaluation. If the user wants to change a design parameter based on the generated response, the CAD model is modified in light of the changed design parameter, and the updated CAD model is converted into a model format suitable for CAE analysis.

The following references relating to CAE of mesh models and are hereby incorporated by reference and are referred to throughout the application as follows:

Beckmann, D, 1994, “Space deformation models survey,” Computer & Graphics, 18(4), pp 571-586 (hereinafter Beckmann, 1994).

Chen, Y, Stewart, P J, Marsan A, Mo, H and Tonshal, B, “A mesh feature paradigm for rapid generation of CAE-based design of experiments data, in Proceedings of ASME DETC'02, DETC02/DAC-34102 (hereinafter Chen et al., 2002)

Chen, Y, Stewart P J, Buttolo, P and Ren, F, 2000, “A real-time, interactive method for fast modification of large-scale CAE mesh models,” in Proceedings of ASME DETC'00, DETC00/DAC 14268 (hereinafter Chen et al., 2000).

Coquillart, S, 1990, “Extended free-form deformation: an interactive animation technique,” Computer Graphics, 24(4) pp 187-193, 1990 (hereinafter Coquillart, 1990).

Lamousin, H J and Waggenspack, W N, 1994, “NURBS-based free-form deformation,” IEEE CG&A, 14(6), pp 59-65 (hereinafter Lamousin and Waggenspack, 1994).

Marsan, A, Chen, Y and Stewart, P J, 2002, “Surface feature parametrization analogous to conductive heat flow,” ASME Journal of Computing and Information Sciences in Engineering JCISE, Vol 2, pp 77-85 (hereinafter Marsan, et al., 2002).

Marsan, A, Chen, Y and Stewart, P J, 2001 “An finite element approach to direct surface manipulation,” in Proceedings of ASME DETC'01, DETC'01/DAC 21103 (hereinafter Marsan, et al., 2001).

Sederberg, T W and Parry, S R, 1986, “Free-Form Deformation of Solid Geometric Models,” in Proceedings of ACM SIGGRAPH '86, pp 1 51-160 (hereinafter Sederberg and Parry, 1986).

Stewart, P J, 1991, “Direct Shape control of free-form curves and surfaces with generalized basis functions,” Ph.D. Dissertation, The University of Michigan (hereinafter Stewart, 1991).

Stewart, P J and Chen, Y, 1999, “Geometric features applied to composite surfaces using spherical reparametization,” in Proceedings of ASME DETC'99, DETC99/DAC-8620 (hereinafter Stewart and Chen, 1999).

Geometric surface features, such as Direct Surface Manipulation (DSM), have proven effective in practice for interactive editing of surface meshes for a variety of CAE applications (Chen et al., 2002) (Marsan, et al., 2002)(Marsan, et al., 2001)(Chen et al., 2000). It is capable of deforming a mesh surface region defined specifically by the user, with a small set of mathematical parameters highly meaningful to the user.

In DSM, an entire surface feature is placed on an existing parametric surface as a single geometric entity. After the DSM surface feature is created, a user of the system that forms the surface feature may control the location, shape and continuity of the feature independently by adjusting corresponding parameters on a real-time basis. Advantageously, DSM provides for modifications to a mesh model without relying on CAD techniques.

Using DSM, a local region of the surface can be deformed quickly and accurately to change a predetermined DSM feature parameter. An example of a modifiable DSM parameter is adjusting the magnitude or height of the deformation, moving, scaling, reorienting, or adjusting the boundary of the deformed region, editing the character of the deformation by changing the underlying DSM basis function, or deleting a DSM feature.

DSM allows a bump or depression to be placed on a mesh model such as the model 20 shown in FIG. 1. The method of forming a bump or depression to be placed on a mesh model is disclosed in (Stewart, 1991)(Chen et al., 2000)(Chen et al., 2002). Basically, a user of a DSM CAE system first sketches a closed curve on a plane, called a sketch plane that defines a boundary of a region to be deformed. A point, curve, or an area inside the boundary is then designated as the region of maximum deformation, wherein the region of maximum deformation is defined as a reference center. The mesh model is then projected onto the sketch plane using either parallel or spherical projection (Stewart and Chen, 1999).

All the nodes of the model projected interior to the feature boundary curve will be displaced by the maximum deformation amount multiplied by a polynomial basis function which provides a scale factor.

After the feature is created, a user may then control the DSM feature's location, size, shape and continuity by adjusting corresponding parameters.

FIG. 1 applies DSM to morphing of a surface mesh 20. FIG. 1 illustrates the process of offsetting an affected mesh node V by (1) (with a whole interior area as the maximum deformation entity). When a node V is found projected interior to a domain of the feature defined by the shaded region 22 on the sketch plane 24, V is parametrized along a radial direction within the domain to obtain a parameter value t, wherein t is used to evaluate the basis function f(t). Thus, the final position of the affected mesh node V defined as V^{new}, can be determined by the following formula refined as EQUATION 1:

V^{new}=V+Dƒ(t). EQUATION 1

wherein V is a node, f is the basis function value at V, t is the result of parameterization of V in the domain of the DSM, i.e. in the space of the feature, and D is the maximum displacement vector, also referred to as a control vector. The basis function f(t) is 0 at the boundary and 1 at the maximum deformation entity.

FIG. 2 illustrates the boundary conditions used to define the basis function f(t), wherein when f(0)=1, then fⁿ(0)=0, for n=1, . . . p, and when f(1)=0, then fⁿ(1)=0, n=1, . . . q.

Where p and q are the required orders of derivative that disappear at t=0 and t=1, respectively. As shown at point 28 in FIG. 2 where f(t)=1, the basis function is mapped to a maximum deformation boundary. As shown at point 26 where f(t)=0, the basis function is mapped to a feature boundary.

FIG. 2 illustrates a normalized basis function within a basis function domain and its defining boundary conditions, wherein the basis function of a DSM surface feature dictates the shape characteristics as well as the geometric continuity between the transitional blended region, the maximum deformation offset region, and regions unaffected by deformation. A basis function domain has two ends that are normalized from 0 to 1.

A DSM surface feature can be applied to multiple parts of a mesh along the way of its projection direction, as shown in FIG. 3. FIG. 3 illustrates a DSM application that determines which area to apply in the case of multiple candidate areas. The dashed lines indicate features that are technically possible to form and the solid lines indicate the actual formation of the feature.

In practice, however, indiscriminately deforming the object along the projection direction can be problematic because areas unintended maybe affected. In the case of large complex models, there can be numerous such areas—most of which the user may not be aware simply because they are obstructed from the view. For this reason, a line-of-sight rule is applied in practice such that the only regions that can be directly observed from the sketch plane can be affected. The line-of-sight rule is further strengthened by taking into account the mesh orientation.

A surface mesh has positive and negative normal directions. When the normal of the sketch plane hits the mesh, a determination is made whether the sketch plane hits the mesh on the positive side of the mesh or not. Features can only be formed on the positive side of the mesh. Moreover, if there are still more than one such areas exist, as is the case in FIG. 3, an inspection of the distance from the hit point to the sketch plane is made and the area with the shortest distance is picked.

The conventional framework of DSM was developed mainly as a surface manipulation tool (Stewart, 1991)(Stewart and Chen, 1999) for application to surface entities, not solid entities. Thus if multiple mesh surfaces exist, only the mesh that is exposed to and closest to the DSM originating space (sketch plane) is selected for deformation while other regions are masked off.

The DSM developer-imposed usability condition was acceptable in the past in part because the meshes used for the CAE applications were simpler and less integrated. For instance, for aerodynamic application, one only deals with a surface mesh representing the exterior shape of a vehicle. A model used for packaging study may only include those that are designed as packaging surfaces of the vehicle. The use of specialty meshes for a specific CAE application makes the tool less restrictive to use despite its limitation.

Various feature-driven and parametric-driven techniques are known in the art for creating a mesh feature, such as Direct Surface Manipulation, Free-Form Deformation and the like.

Although there have been volumetric deformation technologies developed in the past, such as Free-Form Deformation (FFD) family of tools (Lamousin and Waggenspack, 1994) (Beckmann, 1994) (Coquillart, 1990) (Sederberg and Parry, 1986), DSM provides a user of a DSM CAE system direct and precise control over the boundary of the region to be deformed—such a requirement typically triggers subdivisions to achieve the accuracy needed for precise boundary control under the FFD framework at cost of relatively large data volume and increased operator efforts to deal with a large number of control points.

However today CAE models are more complex and integrated than ever before. Meshes, when integrated, may serve for multiple application purposes. For instance, a model that has exterior surface for styling and aerodynamics studies may have interior structure elements for structural analysis studies as well. Crowning the outer surface of the hood, for instance, may require coordinated modification to the inner structural members so that important information concerning the impact on the strength of the hood could be analyzed and fed back to the designer immediately. In addition, the structural member deformation of solid elements must be considered as well.

While existing devices suit their intended purpose, the need remains for a system and method that extends the conventional DSM framework into a volumetric deformation framework.

### SUMMARY

Generally, the present invention provides a process of extending a geometric surface feature framework known as Direct Surface Manipulation into a volumetric mesh modeling paradigm that can be directly adopted by large-scale CAE applications involving models made of volumetric elements, multiple layers of surface elements or both. By introducing a polynomial-based depth-blending function, the conventional DSM mathematics is extended into a volumetric form. The depth-blending function possesses similar user-friendly features as do DSM basis functions permitting ease-of-control of the continuity and magnitude of deformation along the depth of a feature. Several embodiments are disclosed demonstrating the versatility of this volumetric paradigm for direct modeling of complex CAE mesh models.

In addition, a model-independent, volumetric-geometric feature is introduced. Motivated by modeling clay with sweeps and templates, a model-independent, catalog-able volumetric feature can be created. Deformation created by such a feature can be relocated, reoriented, duplicated, mirrored, pasted, and stored independent of the model to which it was originally applied. Such a feature can serve as a design template, thereby saving the time and effort to recreate it for repeated uses on different models for example models created in CAE-based Deign of Experiments study.

The present invention method may be used on a CAE mesh morphing software system that operates to interactively determine a deformation of design mesh models selected from solid meshes, multiple layers of surface meshes, or a combination of each using a base model and defined deformation features. The methodology advantageously defines a volumetric region of the model for modification, maintains a smooth transition between the volumetric region and the rest of the model, and simultaneously modifies all nodes and associated projected nodes within the affected volumetric region in a controlled manner. A new deformation volumetric model feature is created which includes the deformed base model. The methodology takes advantage of similarities between models by treating a set of mathematical operations associated with each mesh deformation as an independent entity that can be stored separately and reapplied to deform another model at another time.

### BRIEF DESCRIPTION OF THE DRAWINGS

These and other objects, features and advantages of the present invention will become apparent from the following detailed description and the appended drawings in which:

FIG. 1 illustrates a process of offsetting an affected mesh node V within a surface deformation region.

FIG. 2 illustrates a graph of a basis function f(t) defining boundary conditions for an area of deformation in accordance with one aspect of the technology.

FIG. 3 illustrates a DSM application that determines which area to apply a deformation region to the case of multiple candidate areas.

FIG. 4 illustrates the effect of depth blending on the deformation of a solid block.

FIG. 5 illustrates a generalized depth blending function and its mapping to the model space.

FIG. 6 provides a cross-section illustration of volumetric regions under different impact from a DSM.

FIG. 7 illustrates definitions of a and b for determination of the depth blending bounds for volumetric deformation.

FIG. 7a illustrates parametric values representing two constant distances, a and b from a sketch plane as the bounds of volumetric deformation, wherein both a and b (defined by b−, and b+) are modifiable by a user of the system.

FIG. 7b shows a sketch plane having two DSM boundary points that define outer limits of an area of a deformation region projected along a ray normal to the sketch plane.

FIGS. 8a and 8b illustrate a cross-sectional illustration of a volumetric DSM definition and user defined or modifiable parameters.

FIG. 9 illustrates a door panel cross section after applying a volumetric DSM having multiple layers of surface meshes.

FIG. 10a illustrates an enlarged view of a DSM feature construction geometry before deformation of a solid rotor model having a plurality of associated slots.

FIG. 10b illustrates an enlarged view of deformation of the solid rotor model shown in FIG. 10a.

FIG. 11 illustrates a vehicle CAE mesh model made up of both exterior surface meshes and interior solid/surface structural meshes.

FIGS. 12a and 12b shows the bumper of the vehicle shown in FIG. 11 before and after deformation, respectively.

FIG. 13 illustrates deformation under a single point of maximum depth blend.

FIG. 13b illustrates curve type of deformation under multiple points of maximum depth blend.

FIGS. 14a and 14b illustrates application of the same curve type of deformation shown in FIG. 13b to a new vehicle bumper.

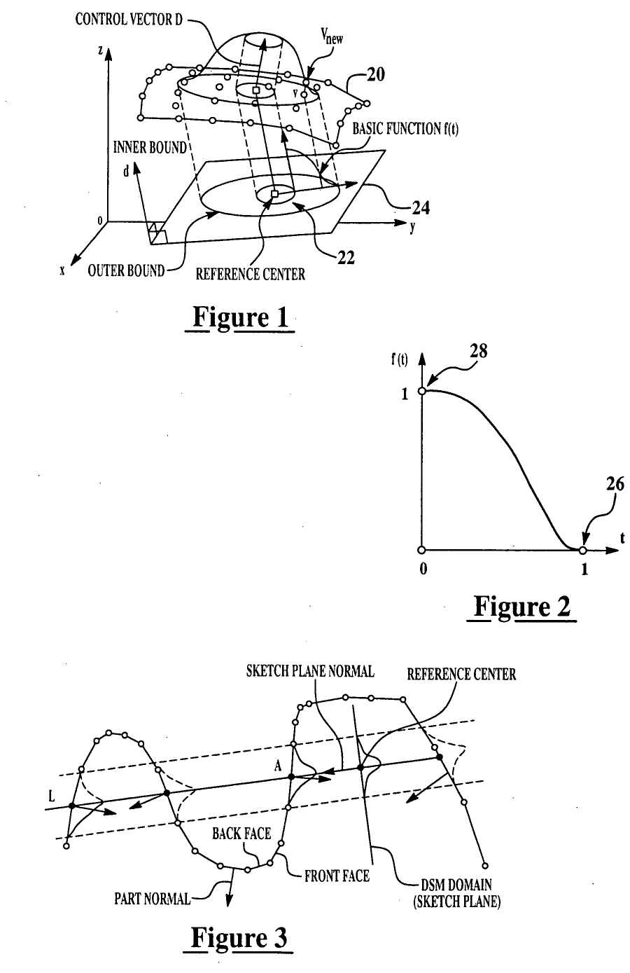

### DETAILED DESCRIPTION OF THE INVENTION

The present invention extends a geometric surface feature framework known as Direct Surface Manipulation into a volumetric mesh modeling paradigm that can be directly adopted by large-scale CAE applications involving models made of volumetric elements, multiple layers of surface elements or both. By introducing a polynomial-based depth-blending function, the conventional DSM mathematics is extended into a volumetric form. The depth-blending function possesses similar user-friendly features as provided by DSM basis functions, thus, permitting ease-of-control of the continuity and magnitude of deformation along the depth of a feature. Practical issues concerning the implementation of this technique are discussed in details and implementation results are shown demonstrating the versatility of this volumetric paradigm for direct modeling of complex CAE mesh models. In addition, the notion of a model-independent, volumetric-geometric feature is introduced. Motivated by modeling clay with sweeps and templates, a model-independent, catalog-able volumetric feature can be treated. Deformation created by such a feature can be relocated, reoriented, duplicated, mirrored, pasted, and stored independent of the model to which it was originally applied. Such a feature can serve as a design template, thereby saving the time and effort to recreate it for repeated uses on different models (frequently seen in CAE-based Deign of Experiments study).

The present methods of creating volumetric DSM features may be implemented on a CAE mesh morphing software system that allows the volumetric feature to apply to solid meshes, multiple layers of surface meshes, or a combination of them.

The present invention provides a simple, yet effective way to extend the conventional DSM framework into a volumetric mesh modeling paradigm. The conventional DSM formulation is extended by introducing a polynomial-based depth-blending function which possesses similar user-friendly features as DSM basis functions permitting ease-of-control of the continuity and magnitude of deformation volume along the projection direction (i.e., depth) of a feature.

The present invention provides a model-independent, volumetric-geometric feature that, once created, can be relocated, reoriented, duplicated, mirrored, pasted, and stored independent of the model to which it was originally applied. Such a feature can serve as a design template, thereby saving the time and effort to recreate it for different models.

Such a feature isolates those nodes for offsetting by only parametrizing and applying EQUATION 1, to a projected interior of the DSM boundary curve(s). A feature such as “surface blending” defines where certain regions of a surface (i.e., maximum deformation entities) are offset by the control vector D, wherein the area outside the DSM boundary remains intact and is not deformed, and the areas in-between the deformed region and the non-deformed or regions unaffected by deformation are transitional areas where blending occurs.

The following groups of formula summarize the three regions before and after a DSM application:

$$\{ \begin{matrix}{V}^{new} = V + Df ( t ) & for … V ∈ {Ω}_{1} \\ {V}^{new} = V + D & for … V ∈ {Ω}_{2} \\ {V}^{new} = V & for … V ∈ {Ω}_{3}\end{matrix} \qquad EQUATION 2$$

where Ω₁, Ω₂ and Ω₃ denote the transitional blended region, the maximum deformation offset region, and regions unaffected by deformation, respectively.

In the conventional DSM framework, a family of basis functions is provided as a set of polynomial functions that operate to control continuity between the transitional region and the maximum deformation offset region, as well between as the transitional region and the regions unaffected by deformation. The basis functions are defined by polynomials having derivatives up to a desired order that disappear at either end of the basis function domain (normalized from 0 to 1).

A representative family of basis functions defining f(t) that can maintain curvature continuity are given in Table 1.

| Basis | |
|---|---|
| functions | Boundary |
| f(t) | conditions |
| 1 − t | G^{0,0} |
| −t² + 1 | G^{1,0} |
| t² − 2t + 1 | G^{0,1} |
| 1 − 3t² + 2t³ | G^{1,1} |
| −t³ + 1 | G^{2,0} |
| 3t⁴ − 4t³ + 1 | G^{2,1} |
| −t³ + 3t² − 3t + 1 | G^{0,2} |
| −3t⁴ + 8t³ − 6t² + 1 | G^{,1,2} |
| 1 − 10t³ + 15t⁴ − 6t⁵ | G^{2,2} |

Table 1 illustrates a family of basis functions that correspond to boundary conditions S, where S equals G^{p,q} and indicates that the geometric continuity that the basis function can be maintained when p at t=0 and q at t=1.

To further extend the DSM framework to volumetric mesh modeling in CAE, a depth blending function is provided to define a deformation region along a projection direction, wherein multiple mesh layers, not only a layer of surface of the DSM framework are affected within the deformation region. The extent of the deformation region is user-controllable.

The volumetric mesh modeling using a modified DSM formula is defined as follows in EQUATION 3:

V^{new}=V+Dƒ(t)g(s). EQUATION 3

The depth blending function is defined as g(s), wherein s is parameter value ranging between [0, 1] and wherein g belongs to the same polynomial family as shown in Table 1. The original DSM formula defined herein in Equation 1 is modified by the depth blending function g(s) to add a volumetric element.

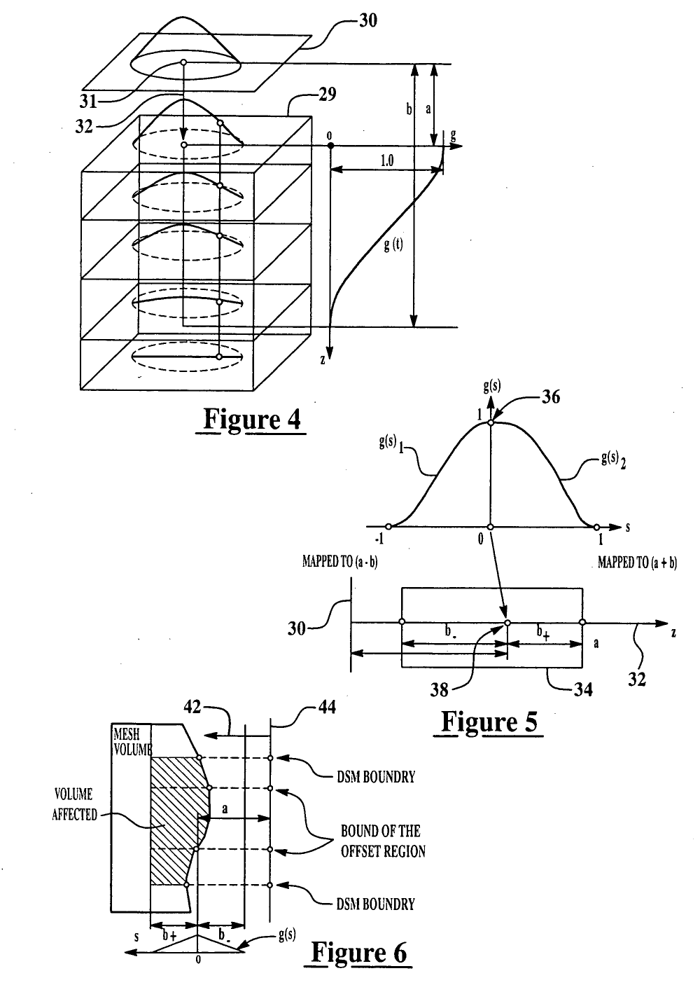

FIG. 4 illustrates the effect of depth blending on the deformation of a solid block. FIG. 4 illustrates a volumetric DSM feature applied to a solid block 29, wherein the maximum deformation entity is a single point 31. In FIG. 4, the range of the affected deformation region along a projection direction, wherein the two values are defined as a and b, wherein a defines a point of maximum deformation along in a positive sketch plane normal direction, and wherein b defines a range from a within the positive sketch plane direction to a negative sketch plane direction. The projection direction is also referred to as a depth of the volumetric deformation region and is normal to the sketch plane 30. The projection direction as shown as a ray 32 normal to the sketch plane 30.

The parametrization of mesh points along the depth based on “a” and “b” is calculated by

$$s = \frac{Zg - a}{b - a} \qquad EQUATION 4$$

wherein s is the distance of a point from the sketch plane. Once s is found, the displacement of a mesh node affected can be calculated by EQUATION 3.

FIG. 5 illustrates a generalized depth blending function and its mapping to the model space. To implement the depth blending function, as shown in FIG. 4 a slight variation of EQUATION 4 is provided and, accordingly, the way the depth-affected region is specified. For continuity consideration, depth function g(s) disappears when a predefined order of derivative is calculated, both at start and end points of the depth range affected. To achieve continuity, two independent g(s) functions, g(s)₁, g(s)₂ may be adopted representing two regions on both sides of the location where the maximum deformation (100%) along the depth direction can occur. The two polynomials, both belonging to those shown in Table, are combined to form a complete depth blending function as shown in FIG. 5.

The two polynomials connect with each other at s=0 where each of their maximum function value of 1 occurs. The point 36 where each of the polynomials connect with each other defines the general blending functions g(s). In a normalized domain, the first polynomial g(s)₁ disappears at s=−1 and the second polynomial g(s)₂ at s=1.

To apply the depth blending function g(s), the normalized domain must be mapped to the actual range along the depth direction.

As shown in FIG. 5 the value b (shown in FIG. 4) is further defined by a value b₊ and b₋, wherein b₊ defines a range between a within the positive sketch plane direction and the boundary of the deformation region, and wherein b defines a range in a negative sketch plane direction. The shaded area 34 defines a range along the sketch plane normal ray 32 that defines the deformation volume. If the point of maximum depth blending, a, occurs at a distance from the sketch plane frame and affected region is b₊ ahead of a and b back from a, then the normalized depth blending domain has the following mapping relationships to the actual model: [−1, 0] to [a−b₋, a] and [0, 1] to [a, a+b₊].

Note that in this more general formulation, the two g(s) functions g(s)₁, g(s)₂ can be independent of each other. Ranges before and after the maximum depth blending are not necessarily the same, either.

Under these general assumptions, EQUATION 2 becomes:

$$\{ \begin{matrix}{V}^{new} = V + Df ( t ) g ( s ) & for … V ∈ {Ω}_{1} & and … z ∈ [ a - {b}_{-} , a - {b}_{+} ] \\ {V}^{new} = V + Dg ( s ) & for … V ∈ {Ω}_{2} & and … z ∈ [ a - {b}_{-} , a - {b}_{+} ] \\ {V}^{new} = V & for … V ∈ {Ω}_{3} & \end{matrix} \qquad EQUATION 5$$

wherein z is the z coordinate of the node V in the sketch plane coordinate system.

A maximum deformation point 38 is shown in FIG. 5 along sketch plane Z.

Several methods of the present invention disclose how to define a and b. One method is to let a user define a point of maximum deformation, a, along sketch plane normal. The user then specifies b₊, a range from a in the positive sketch plane normal direction and b₋, a range negative from the positive sketch plane direction. An illustration of this approach is given in FIG. 6.

An illustration of regions under the general depth blending is given in FIG. 6. FIG. 6 provides a cross-section illustration of volumetric regions under different impact from a DSM.

Transforming the sketch plane 44 along its normal direction 44 will change the deformation region if a and b's are provided relative to the sketch plane. It is desired for the purpose of maintaining viewing flexibility that translating a sketch plane along its normal direction would not affect the volumetric deformation region result. Often a user moves the sketch plane away from the model this way in order to have a better view of the operation. This property may be provided automatically for the conventional surface DSM operation.

As shown earlier in FIG. 3, moving the sketch plane may affect the decision where to form a surface feature. However, if the plane is located entirely outside the surface envelope, moving the sketch plane further away from the surface in the direction of the sketch plane normal will not affect the result when parallel projection is used for parametrization. When a sketch plane is created relative to one model and is later applied to a different model vehicle, it may require that the plane be repositioned along sketch plane normal when, for instance, the two vehicles are different in size. As such a and b's created for one model are most likely invalid for another and has to be re-defined.

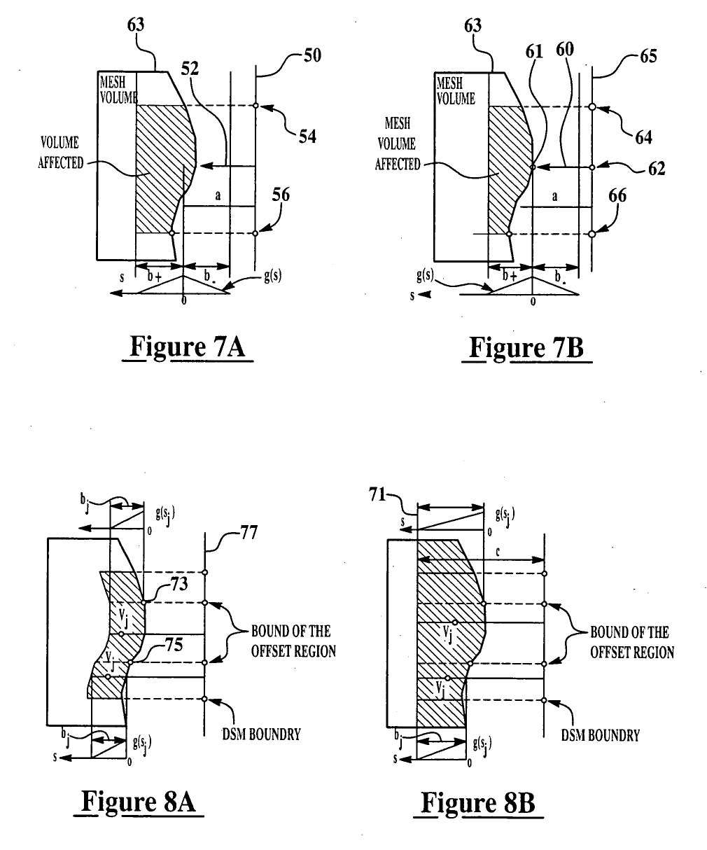

FIG. 7 illustrates definitions of a and b for determination of the depth blending bounds for volumetric deformation. In FIG. 7a, two constant distances are defined from the sketch plane 54 as the bounds of volumetric deformation, wherein both a and b (defined by b−, and b+) are modifiable by a user of the system.

In order to make the volumetric DSM operation more model independent and to thus, achieve maximum reusability, the DSM operation defines the DSM reference point 61 as a point of reference for a, while the specifications of b's remain the same as the b's shown in FIG. 7a. This method is depicted in FIG. 7(b). FIG. 7b shows a sketch plane 50, having two DSM boundary points 54, 56 defining outer limits of an area of a deformation region projected along the ray 52 normal to the sketch plane 50. FIG. 7b, the center of the affected volume 61 is obtained by projecting a single DSM reference point 62 onto the boundary representation of the solid 63. The range of the volumetric deformation region is set by a user of the system wherein 64, and 66 define two DSM boundary points and ray 60 defines the sketch plane normal to the sketch plane 65.

FIGS. 8a and 8b illustrate a cross-sectional illustration of a volumetric DSM definition and user parameters. Shaded regions 67 and 69 shown in FIGS. 8a and 8b respectively show the bounds of the volume affected under the volumetric DSM deformation. As illustrated in FIG. 8(a), different points, such as Vᵢ and Vⱼ, correspond to different ranges of depth depending on their corresponding exit points 73, 75 on the boundary mesh surface. The affected volume is therefore a constant, parallel offset having a maximum depth deformation volume of bⱼ from the exit points 73, 75 inward from the boundary of the solid facing in the positive normal direction from the sketch plane 77. Alternatively, as shown in FIG. 8b a user of the system may set a plane 71 that defines a farthest extent from which the volume of the deformation region can be affected. Thus, the value c is modifiable and the value bⱼ is calculated to define a depth of volume along positives sketch plane normal direction between an associated exit point along the boundary surface and the plane 71.

In the conventional DSM framework, maximum offset entities are controlled directly by the control vector including both a displacement amount and a direction of the displacement. However, according to EQUATION 5, the maximum offset region of volumetric deformation is scaled by the blending function g(s). Discontinuity can happen easily when the maximum offsetting entities are allowed to move in parallel.

To prevent discontinuity, the boundary surface mesh of a solid model is allowed to deform the same way as a pure surface mesh. Thus, the depth blending function has a value of 1 for nodes residing on the boundary surface mesh of the solid model.

Under this scheme, EQUATION 5 becomes:

$$\{ \begin{matrix}{V}^{new} = V + Df ( t ) g ( s ) & for … V ∈ {Ω}_{1} & and … z ∈ [ a - {b}_{-} , a - {b}_{+} ] \\ {V}^{new} = V + Dg ( s ) & for … V ∈ {Ω}_{2} & and … z ∈ [ a - {b}_{-} , a - {b}_{+} ] \\ {V}^{new} = V & for … V ∈ {Ω}_{3} & \end{matrix} \qquad a . EQUATION 6$$

To achieve the depth blending function having a value of 1 for nodes i residing on the boundary surface mesh, a individualizes into aᵢ.

Using the method of the present invention, when a node inside the solid is to be evaluated for its displacement, the point is first projected along the sketch plane normal onto the sketch plane. The point where the ray leaves the boundary surface of the solid is then treated as the location where aᵢ is defined for node i.

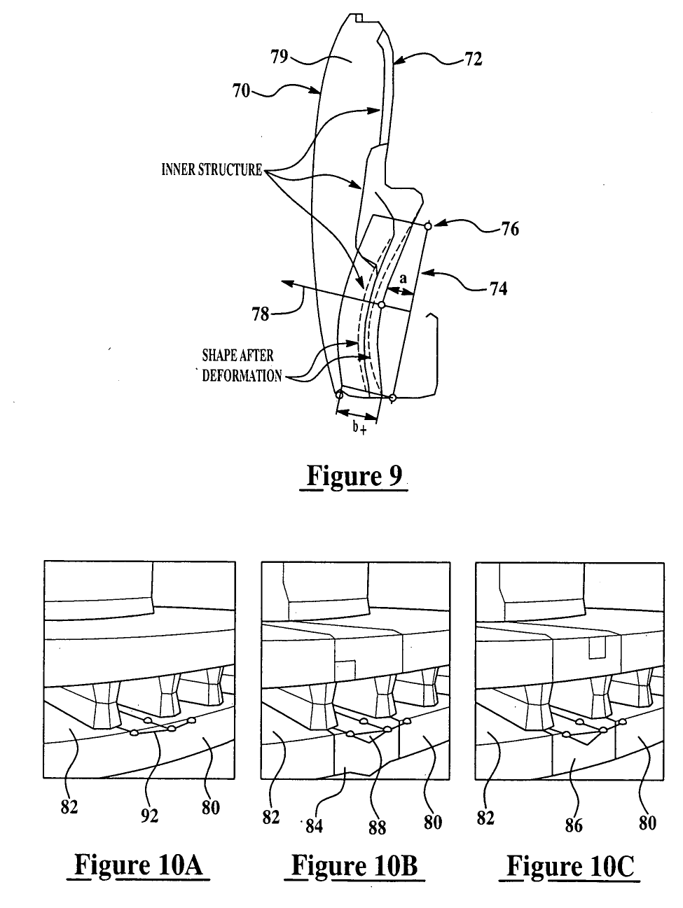

The individualized reference points of the mesh nodes may be used for deformation of models that have multiple layers of surface meshes, such as a door panel under deformation (both inner and outer panels) as shown in FIG. 9.

FIG. 9 illustrates a door panel cross section 73 after applying a volumetric DSM having multiple layers of surface meshes. The door panel cross section 73 provides a door panel exterior sheet metal 70, door panel interior trim 72, having an inner structure which is the inside boundary of the door subassembly. As shown in FIG. 9, a large depression is applied to a lower part the door panel along a ray 78 normal to a sketch plane 74, thereby causing interior structure member to deform as well. DSM boundary 76 defines an upper boundary limit of an area region of the sketch plane 74. As shown, aᵢ is individualized between associated nodes along a boundary surface of the interior trim and the sketch plane 74. The affected region of deformation is defined by b+.

In a conventional DSM application, each mesh feature is defined by a sequence of mathematical operations used to displace a set of mesh nodes in order to achieve a particular deformation effect on the model. The mesh features share common characteristics, that is, each is definable using a modifiable set of parameters. Each mesh feature is stored in a feature library as an independent entity that is applied to the model, and the defining parameters of the feature are described in a local coordinate frame that is independent of the model to which the feature may be applied. The mesh feature may include a homogeneous transformation matrix as part of its definition.

Similar to the conventional DSM mesh application feature, a volumetric feature can also be made into a catalog-able feature that is model-independent. In other words, none of the critical, character-defining parameters of the volumetric feature depends on the model to which the deformation is applied. The parameters include the sketch plane, the boundary curves, the maximum deformation entities on the sketch plane, the basis function, and the depth function, and the like.

A catalog-able volumetric feature, therefore, initially provides from a local frame from which the sketch plane (location and normal direction) is defined relative to the model space. The sketch plane defines the bulk of feature parameters, such as, but not limited to the boundary curve and the reference point. The local frame may then be repositioned, reoriented, and may also mirror an existing feature when a proper transformation is applied to the local frame.

The sketch plane defines boundary curves and provides a plane equation, an origin on the plane and two axes, based on the coordinate system, a boundary curve (e.g., a Cubic NURBS curve defined in the plane coordinate system), a set of maximum deformation entities including points, open curves, or closed curves, a point representing a location of the reference point, and a maximum deformation vector. Each of the elements of the sketch plane can be specified in combination with the projection direction (i.e., a vector) and parametrization type.

FIGS. 7a, 7b, and 8b provide a process defining the limit of volumetric deformation along the sketch plane normal direction. If the process indicates that independent a's and b's are to be adapted, then each a, b and b₊ relative to the sketch plane are defined as shown in FIG. 7a. Alternatively, a may defined each time a volumetric DSM feature is applied by intersecting a ray with the boundary of a mesh model to be deformed, as shown in FIG. 7b and wherein b₋, b₊ are predefined. Alternatively, an absolute limit of the volume deformation, as measured by a distance c along the sketch plane normal shown in FIG. 8b from the sketch plane can also be defined instead of predefining b₋, and b₊, wherein bⱼ may be calculated in accordance with a distance between c and exit points along the boundary surface.

In addition, parameters defining both basis and depth blending functions are specified. After a volumetric feature is created, the user can control the DSM feature's location, size, shape, and continuity (with the surface to which the feature is applied) independently by adjusting corresponding parameters. The volumetric feature can be stored independently of the model for reuse in the future. Thus, the catalog-able volumetric feature allows maximum reuse of a volumetric feature once it is created.

A user of the CAE mesh morphing software system can chose to create a conventional DSM feature, which affect only one layer of surface, or a volumetric one whose influence is bounded only by the two planes spanning equal distance from the location where the maximum depth bending is located. The location of the maximum depth blending can be either the projection of the reference point onto the boundary of mesh(es) affected, or alternatively, it can be specified relative to the sketch plane along it normal direction. When dealing with an area or curve type of maximum offset entities, a user can choose to individualize the location of maximum depth blending so that they will be displaced in parallel (like a rigid body). Under this circumstance, b is a constant value from the point of maximum depth blending.

FIG. 10a illustrates an enlarged view of a DSM feature construction geometry before deformation of a solid rotor model 80 having a plurality of associated slots 82. In FIG. 10a, a volumetric feature 92 is constructed and the sketch plane is positioned to “notch” the lower side of one of the slots 82.

FIG. 10b illustrates an enlarged view of deformation of the solid rotor model 80 having the plurality of associated slots 82 shown in FIG. 10a. As shown in FIG. 10b, deformation 84 is applied to the model when a user-specified depth showing that the upper part of the slot is also affected. In FIG. 10b, the deformation displayed results from a predefined b 88 being set as too large of a default value. Accordingly, a is defined as the reference point projected onto the rotor slot.

FIG. 10c illustrates the blended transition region 86 formed in accordance with the present invention providing an affected region within the depth blend range. The b predefined in FIG. 10b is adjusted in accordance with the depth blending function, thus, allowing a user to achieve a desired effect shown in FIG. 10(c).

Although not shown, the model shown in FIGS. 10a-10c is a solid model including a plurality of solid elements inside the rotor 80, wherein each of the affected interior solid elements is simultaneously repositioned, accordingly.

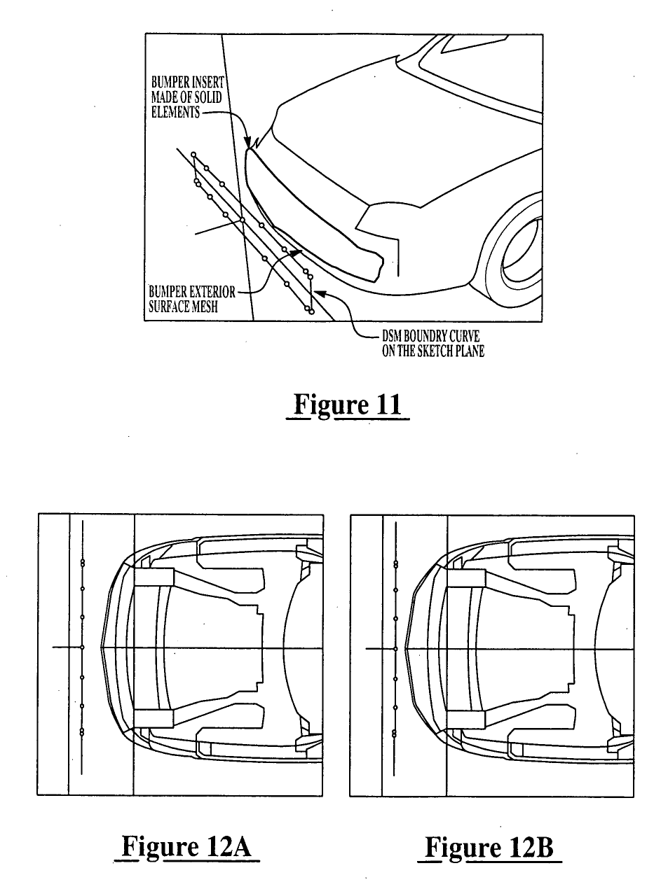

FIG. 11 illustrates a vehicle CAE mesh model made up of both exterior surface meshes and interior solid/surface structural meshes. FIG. 11 illustrates modification of a portion of a front bumper of a vehicle CAE model that has both a “skin,” i.e., an exterior sheet metal surface, and interior structural members of the vehicle. In FIG. 11, an attempt is made to extend the bumper forwardly by 150 mm and to blend the newly formed extrusion smoothly with the rest of the bumper. A solid insert model is located behind the bumper surface representing the structural filling of the bumper. Accordingly, is it desirable to modify the solid insert model when modifying the bumper surface.

As shown in FIG. 11, a sketch plane is positioned in front of the bumper and a curve is sketched to define an area of the feature that will be affected by deformation. As shown in FIG. 11, a reference point is pulled forward 150 mm and is used as a projection on the bumper surface as the location of maximum depth blending. Each of the b's are set equal to each other, wherein b₋=b₊ so that the bumper insert is included within the depth blending range.

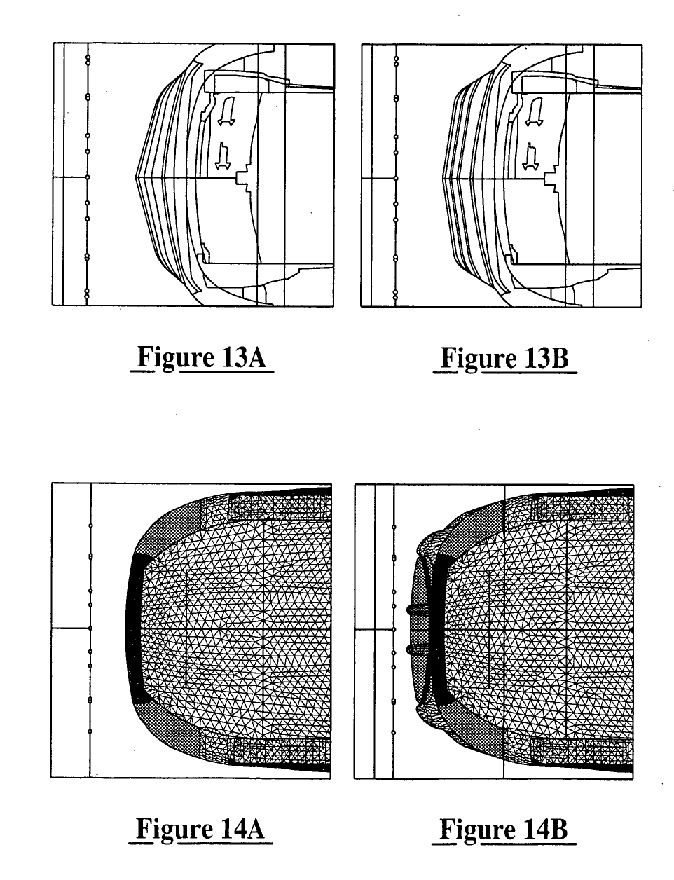

FIGS. 12(a) and (b) show the bumper in FIG. 11 before and after deformation, respectively.

In an alternative embodiment shown in FIG. 13, a front bumper of the same vehicle model is modified. FIG. 13 illustrates deformation under a single point of maximum depth blend, and FIG. 13b illustrates deformation under multiple points of maximum depth blend. Instead of pulling a point to a maximum displacement location and blending the rest of the affected area as disclosed with reference to FIG. 12 herein, a curve that spans about two-third of the affected region is pulled with the purpose of preserving the shape of that section of the bumper during stretching. Accordingly, the solid bumper insert is modified simultaneously. The location of maximum depth blending for each affected mesh node is then individualized. As shown in FIG. 13 (a), the shape of the bumper spanned by the curve cannot be preserved without each individualized reference.

Thus, adopting a single point of maximum depth blending, which is the center point of the curve projected onto the bumper surface mesh does not preserve the shape of the bumper. This is because of the varying distance of the curve from the sketch plane, wherein the depth parameter value s is different depending on the point on the curve, and so is g(s). As a result, the curve is not displaced in parallel, rather, the effect of g(s) scaling is coupled with the deformation, causing the bumper profile (top view) to lose its original shape.

In FIG. 13(b), each mesh node provides its own location of maximum depth blending, which is the intersection between the bumper surface and a line passing through each mesh node in the direction of sketch plane normal. As such, the bumper surface is displaced exactly like it would be under a conventional DSM surface deformation. A constant offset allows the solid insert behind the bumper to deform in a coordinated fashion simultaneously. However, the original, uniform gap between the bumper surface and the insert may not be maintained precisely, but the loss of uniformity can be controlled by choosing a proper depth blending function g(s) that corresponds to a value not close to the peak function value, such as G^{2,1} or G^{2,0} function as disclosed in Table.

Three different ways of defining the location of maximum depth blending provide a variety of applications with the tools needed to achieve specific effects of volumetric mesh deformation. The volumetric deformation with individualized locations of maximum depth blending preserves the effect of the conventional DSM and thus, may be most intuitive to those who are already users of the conventional DSM.

FIGS. 14a and 14b illustrates application of the same curve type of deformation shown in FIG. 13b to a new vehicle bumper: before deformation, as shown in 14a, and after deformation, as shown in FIG. 14b. FIGS. 14a, 14b demonstrate the utility of a catalog-able feature by illustrating that the same volumetric feature can be stored and applied to modify the bumper of a different vehicle.

In operation, the sketch plane is repositioned in response to the different dimension and vehicle coordinate system, and the boundary curve of the deformation region is slightly modified. However, after the manual adjustments of the sketch plane and the associated boundary curve of the deformation region, the deformation of the volumetric feature is provided automatically, thus allowing for minimal user effort.

As CAE becomes a more cost- and time-effective alternative to the traditional mechanical design and engineering approaches utilizing physical prototypes, the need has increased dramatically for the capability to directly reshape mesh models rather then CAD models. The present invention extends the conventional DSM surface feature framework into the area of volumetric morphing complex mesh models. This is achieved by introducing a polynomial depth-blending function, which effectively extends the area deformation into volume deformation. The depth-blending function possesses similar user-friendly features as the conventional DSM basis functions permitting ease of control of the continuity and magnitude of deformation along the depth of a feature. The present invention provides versatility for direct modeling of complex, product-level CAE meshes. In addition, a model-independent, volumetric-geometric feature is provided that can be reused repeatedly for future applications once a volumetric deformation feature is created.

While the methods described herein illustrate parallel projection, the present invention may also be applied to spherical projection. It is contemplated that the present invention may extend to a DSM feature formed by spherical projection as opposed to parallel projection. Spherical projection allows an very curvy area of model to project into the sketch plane with reduced special distortion, and thus better quality of the ultimate shape. Details of this paradigm is found in (Stewart and Chen, 1999).

While several aspects have been presented in the foregoing detailed description, it should be understood that a vast number of variations exist and these aspects are merely an example, and it is not intended to limit the scope, applicability or configuration of the invention in any way. Rather, the foregoing detailed description provides those of ordinary skill in the art with a convenient guide for implementing a desired aspect of the invention and various changes can be made in the function and arrangements of the aspects of the technology without departing from the spirit and scope of the appended claims.

What is claimed is:

1. A process of volumetric mesh modeling comprising:
transforming a Direct Surface Manipulation (DSM) feature framework into a volumetric mesh model having an affected deformation region.

2. The process of claim 1, further comprising:
providing a polynomial depth-blending function that transforms a DSM area deformation feature into a volumetric deformation feature of the volumetric mesh model.

3. The process of claim 2, further comprising:
using the depth blending on the deformation of a mesh model representing a solid block; and
defining a range of the affected deformation region along a projection direction, wherein the projection direction is normal to a corresponding sketch plane and further corresponds to two values, wherein the two values are defined as a and b, wherein a defines a point of maximum deformation along in a positive sketch plane normal direction, and wherein b defines a range from a within the positive sketch plane direction to a negative sketch plane direction.

4. The process of claim 3, wherein the value b is further defined by a value b₊ and b₋, wherein b₊ defines a range between a within the positive sketch plane direction and the boundary of the deformation region, and wherein b₋ defines a range in a negative sketch plane direction.

5. The process of claim 1, further comprising:
applying a depth blending function to add volumetric element to the DSM feature framework, wherein the depth-blending function is defined as g(s), wherein s is parameter value ranging between [0, 1] and wherein g belongs to a polynomial family associated with providing continuity to a basis function.

6. The process of claim 1, further comprising:
deforming the volumetric mesh model along a depth that is normal to a sketch plane associated with the volumetric mesh model.

7. The process of claim 1, further comprising:
providing continuity and magnitude along a depth of the affected deformation region of the volumetric mesh.

8. The process of claim 1, wherein the volumetric mesh model represents a three-dimensional solid mesh.

9. The process of claim 1, wherein the volumetric mesh model represents multiple layers of surface meshes.

10. The process of claim 1, wherein the volumetric mesh model represents a combination of a three-dimensional solid mesh and multiple layers of surface meshes.

11. The process of claim 1, further comprising:
using parallel projection to form the volumetric mesh model.

12. The process of claim 1, further comprising:
using spherical projection to form the volumetric mesh model.

13. A process of volumetric mesh modeling comprising:
defining a volumetric mesh having an associated boundary surface defined by a plurality of surface mesh nodes;
isolating selected surface mesh nodes from the plurality of surface mesh nodes on the volumetric-geometric mesh;
defining a deformation region having a deformation boundary along the isolated selected nodes of the volumetric-geometric mesh;
defining a sketch plane associated with the deformation boundary of the deformation region;
offsetting the isolated selected nodes of the volumetric-geometric mesh along a depth of a ray normal to the sketch plane; and
providing a depth blending function to the deformation region.

14. The process of claim 13, further comprising:
parametrizing the offset isolated selected nodes of the volumetric-geometric mesh; and
applying a DSM function to a projected interior of an associated DSM boundary curve.

15. The process of claim 14, wherein the step of applying a volumetric DSM feature is applied to a solid object.

16. The process of claim 13, wherein the step of defining a deformation region, further comprises:
providing an associated maximum deformation entity within the deformation region, wherein the maximum deformation entity is selected from at least one of the group consisting of a single point, a closed curve, and an open curve.

17. A process of volumetric mesh modeling comprising:
creating a deformation design template of the volumetric-geometric feature.

18. The design template of claim 17, wherein the deformation design template defines a model-independent, volumetric-geometric catalog-able feature capable of being relocated, reoriented, duplicated, mirrored, pasted, and stored independent of a model to which the volumetric deformation feature was originally applied.

19. The design template of claim 17, wherein the deformation design template defines a model-independent, volumetric-geometric catalog-able feature capable of being relocated, reoriented, duplicated, mirrored, pasted, or stored independent of a model to which the volumetric deformation feature was originally applied.
